(19) United States
(12) Patent Application Publication
(10) Pub. No.: US 2018/0216403 A1
(43) Pub. Date: Aug. 2, 2018

(54) Reduced Motor Drive Shaft For Retractable Curtain Assembly

(71) Applicants: Ashraf Gomaa, Stony Brook, NY (US); Andrew C. Lambridis, Dix Hills, NY (US); Oscar Escobar, Glendale, NY (US)

(72) Inventors: Ashraf Gomaa, Stony Brook, NY (US); Andrew C. Lambridis, Dix Hills, NY (US); Oscar Escobar, Glendale, NY (US)

(73) Assignee: McKeon Rolling Steel Door Co., Inc.

(21) Appl. No.: 15/882,616

(22) Filed: Jan. 29, 2018

(30) Foreign Application Priority Data
Jan. 27, 2017 (US) 62451162

(51) Int. Cl. E06B 9/58; E06B 9/72; E06B 9/44; E06B 9/171

(52) U.S. Cl. CPC E06B 9/581; E06B 9/72; E06B 2009/587; E06B 9/171; E06B 9/44

(57) ABSTRACT

A curtain assembly includes: a pair of support brackets; a curtain; members arranged at each lateral side edge portion of the curtain and vertically spaced from one another; a pair of guides defining a space to be traversed by the curtain, the pair of guides having a narrower portion that prevents the edge portions of the curtain with the locking members from disengaging from the guides; a roller barrel assembly configured as a take up roller upon which the curtain is wound; and a respective reduced diameter shaft arranged between each end of the roller barrel assembly and a respective support bracket, each respective reduced diameter shaft configured as a take up roller that stores the lateral side edge portions of the curtain having the plurality of locking members.

### CROSS REFERENCE TO RELATED APPLICATIONS

This application claims priority from U.S. Provisional Patent Application Ser. No. 62/451,162 which was filed on Jan. 27, 2017.

### BACKGROUND OF THE INVENTION

### Field of the Invention

The present invention is directed to motor driven curtain assemblies that employ curtains having wider or thicker edge portions, such as, for example, thickening members (also known as “poppers”) alongside side edges of a curtain, to secure the side edges of the curtain in guides along which the curtain travels between deployed and retracted positions.

### Discussion of Related Art

In conventional rolling steel fire doors made of connected metal slat members, the slats of the door include, at each end, endlocks which, during operation of the door, ride along, and inside of a guide. Wind locks are also deployed at the slat edges to maintain the door within the guide in the event of a force, such as is caused in a high wind condition. The guides are affixed, in various known manners, directly or indirectly, to each side wall defining a space to be traversed by the door.

In the case of fire curtains, on the other hand, endlocks and wind locks are not employed. Thus, it is known to arrange, at side edge portions of the curtain, an increased thickness material, device or member which perform a locking function to maintain the curtain edges in the guides. One such type of locking device are referred to herein as “poppers”.

Poppers are spacer elements sandwiching the curtain material along the curtain sides, e.g., the left side edge and right side edge, at vertically spaced-apart intervals. These elements provide a thickening structure to the curtain edges. Thus, when the curtain is deployed in an assembly, the poppers are positioned in the guides and prevent the edges of the curtain from disengaging from the guides in the event of a pressure differential from one side of the curtain to the other—such as in a fire, air pressure, or wind condition.

During assembly, the poppers are fastened along the left and right side edges of the curtain and then the curtain is installed about an opening, the sides of which contain a back portion of the left and right guides. Thereafter, the front portions of the guides are mounted such that the opening between the back and front portions of each guide is narrower than a width of the popper. This arrangement maintains the edges of the curtain within the guide but allows the remaining span of the curtain material to extend through the guides. In other words, the poppers in cooperation with the guides maintain the edges of the curtain in the guides while allowing the expanse of the curtain to extend across the opening or space across which the curtain is deployed.

However, a problem can occur when curtains with poppers are rolled up on roller barrels. As the curtain is rolled about the roller barrel assembly, the poppers add to the thickness of the rolled up curtain at the edge portions. The resulting diameter of the overall thickness in this “popper” region will exceed the diameter of the rolled up curtain along the remainder of the roller barrel. This, in turn, poses a problem because extra space in the header region will now be required to conceal the increased thickness rolled—up curtain.

This problem is illustrated in FIG. 1 showing a detailed view of one end (e.g., a left-side, etc.) of a curtain assembly 100 with a barrel driven by a conventional tubular motor drive unit 102 having motor drive support and locking blocks 101. The conventional motor drive unit 102 is substantially the same diameter as the roller 104. The roller 104 acts as a take up roller that stores the curtain in the un-deployed/retracted or partially deployed condition and from which the curtain is deployed. The motor drive unit 102 is supplied power via electric wires 106 and interfaces with the motor drive support and locking blocks 101 that surround support bracket 108.

FIG. 1 shows a curtain 110 in a rolled up position. When the curtain 110 is rolled up, the curtain retaining end poppers 112, having a greater thickness than the rest of the curtain, causes a thickening of the overall rolled up curtain 110 at the edge portions thereof. As can be seen from FIG. 1, this causes an increased thickness to form at the edge of the roller 104 around the motor drive unit 102, as well as at an opposite edge of the curtain.

Thus, there is a need for an assembly that solves the problems described above.

Although the above-arrangement is described in the context of a vertical (i.e., up and down deployable) curtain, wherein poppers are used to secure the left and right side edges of the curtain in the guides, a similar problem will result in horizontal curtains that are arranged to move sideways across an opening. The problem also occurs simply from the thickening or widening of the curtain edges, regardless of the use pf poppers, such as by forming an increased width of the curtain material at the edges, or by using any other device to increase the thickness of the curtain edges to maintain the edges in the guides.

### SUMMARY OF THE INVENTION

According to one aspect of the invention, an assembly is provided having a reduced diameter motor drive shaft aligned with the curtain edges presenting an increased thickness of the curtain. The reduction in diameter is selected so that when the curtain is in the rolled up state, the total overall diameter of the roller barrel and curtain edges will be reduced.

According to one aspect of the invention, a curtain assembly includes: a pair of support brackets; a pair of guides positioned directly or indirectly to each side wall; a curtain having lateral edges and positioned so that the lateral edges are moveable within a channel defined by the guides; a locking member arranged at each lateral side edge portion and positioned within the guide channels, the pair of guides having a narrower portion that allows the curtain to pass therethrough but prevents the edge portions of the curtain with the locking members from disengaging from the guides; a roller barrel assembly configured as a take up roller that stores the curtain in an un-deployed/retracted or partially deployed condition upon which the curtain is wound; and a respective reduced diameter shaft arranged between each end of the roller barrel assembly and a respective support bracket, each respective reduced diameter shaft configured as a take up roller that stores the lateral side edge portions of the curtain having the locking members.

According to one aspect of the invention, the curtain assembly further comprises at least one tubular motor drive unit arranged at a first lateral end of the roller barrel assembly and the reduced diameter shaft is a reduced motor drive shaft of the tubular motor drive unit. Motor drive support and locking blocks are arranged at at least one of the support brackets.

According to one aspect of the invention, the tubular motor drive unit has substantially a same diameter as the roller barrel.

According to one aspect of the invention, the curtain assembly includes a second tubular motor drive unit arranged at a second lateral end of the roller barrel assembly opposite the first lateral end of the roller barrel assembly.

According to one aspect of the invention, one or more electrical connections for the tubular motor drive unit pass through the reduced diameter shaft.

According to another aspect of the invention, a plurality of locking members are disposed along each lateral edge of the curtain, in a spaced-apart arrangement, and wherein the locking members are so-called “poppers”.

While described as a vertically operated curtain, a horizontally disposed curtain or side-coiling curtain can be constructed in accordance with the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The figures are described as follows:

FIG. 1 is a section view of a conventional tubular motor design for a vertical fire curtain assembly;

FIG. 2 is a view of a vertical fire curtain assembly according to an embodiment of the present invention;

FIG. 3 is a right upper perspective view of the fire curtain assembly shown in FIG. 2;

FIG. 4 is a section view of an enhanced tubular motor design for a fire curtain assembly according to an embodiment of the present invention; and

FIGS. 5 and 6 are sectional views illustrating two exemplary embodiments showing locking mechanisms configured as poppers arranged and held within curtain guides.

### DETAILED DESCRIPTION OF THE PRESENTLY PREFERRED EMBODIMENTS

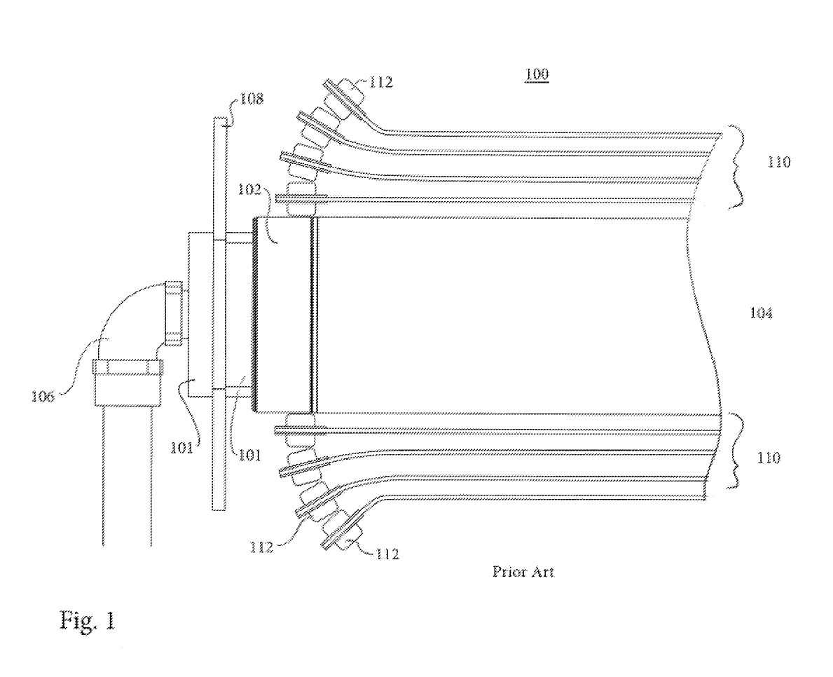

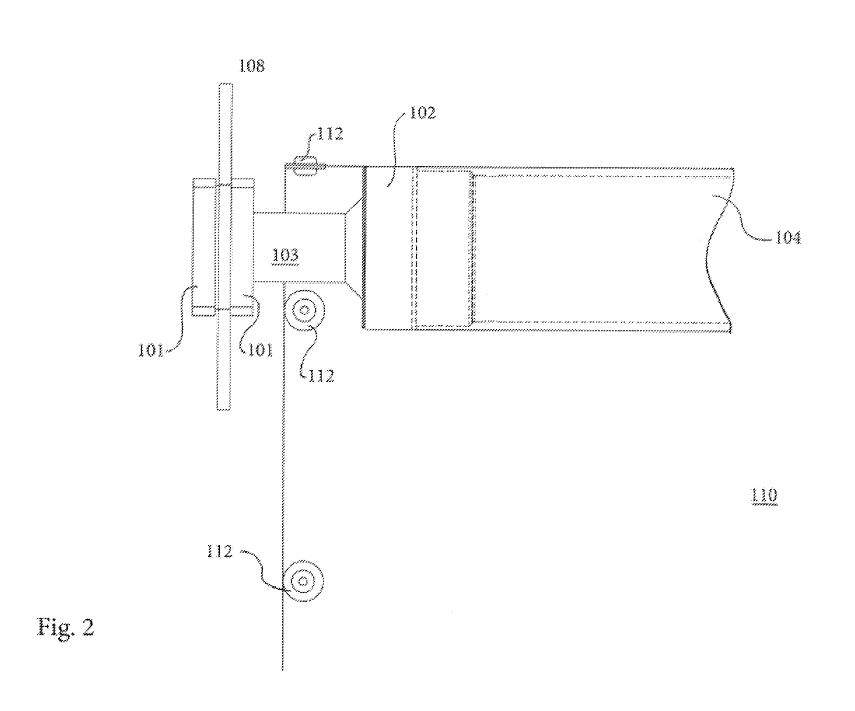

With reference to FIGS. 2-4, structural elements that are unchanged from those shown in FIG. 1 are similarly numbered.

FIGS. 2-4 illustrate a fire curtain assembly 1 having an enhanced tubular motor design. The enhanced tubular motor design is advantageously arranged to solve the problems of the prior art discussed above.

In particular, as can be seen in FIGS. 2-4, to provide space between the motor drive 102 arranged at the end of the roller assembly barrel 104 and the motor drive support and locking blocks 101, the motor of the assembly according to an embodiment of the present invention further includes a reduced diameter drive shaft 103. As can be seen, for example in FIG. 2, the reduced diameter shaft 103 is located in the area, here shown only at the left side edge of the curtain 110, at which curtain locking members 112, shown, for example, as poppers, are located. Curtain edge locking members are also affixed to the right side edge of the curtain (not shown) in a similar manner. In one embodiment of the invention the locking members are configured as a thickened portion of the curtain 100 so that the curtain 100 has a substantially T-shaped configuration 112a at each lateral end. The locking members can have other configurations that increase a thickness of the curtain 100 so that the thickened portion is greater than a narrower portion 204 of the guide 202.

In one embodiment of the invention a traditional drive motor is utilized and the reduced diameter shaft 103 couples the motor to the roller assembly barrel 104. In another embodiment, a manual opening/closing operator is used and the reduced diameter shaft 103 couples the manual opening/closing operator to the roller assembly barrel 104.

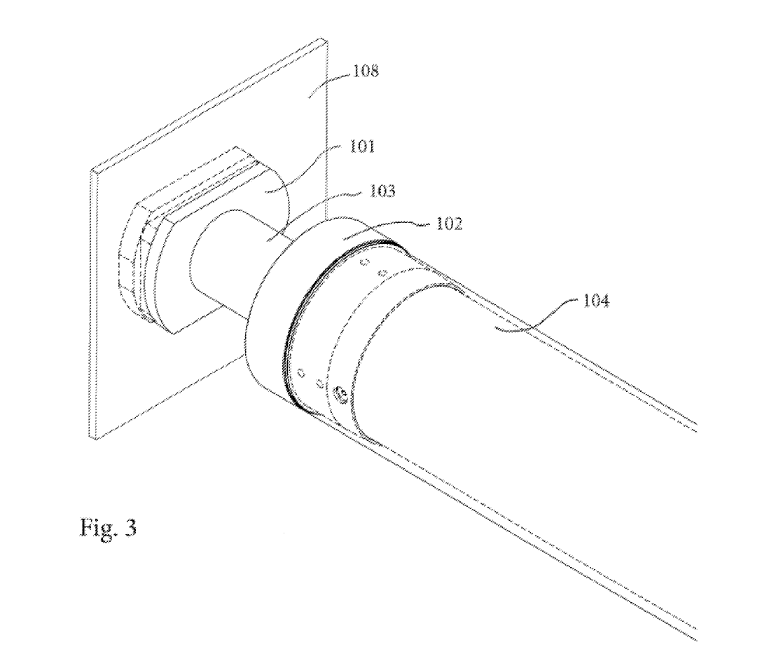

As shown in the FIG. 2, the locking members 112 (e.g., poppers), are located on the left side of the curtain 110, and align vertically so that, as the curtain 110 is wound onto the roller barrel assembly 104, the portion of the curtain 110 to which the end poppers 112 are affixed travels only over and around the reduced motor drive shaft 103, and does not feed onto the larger diameter portion of the motor drive 102 or the roller barrel assembly 104. FIG. 3 is a perspective view of the curtain assembly shown in FIG. 2 but without the curtain 110.

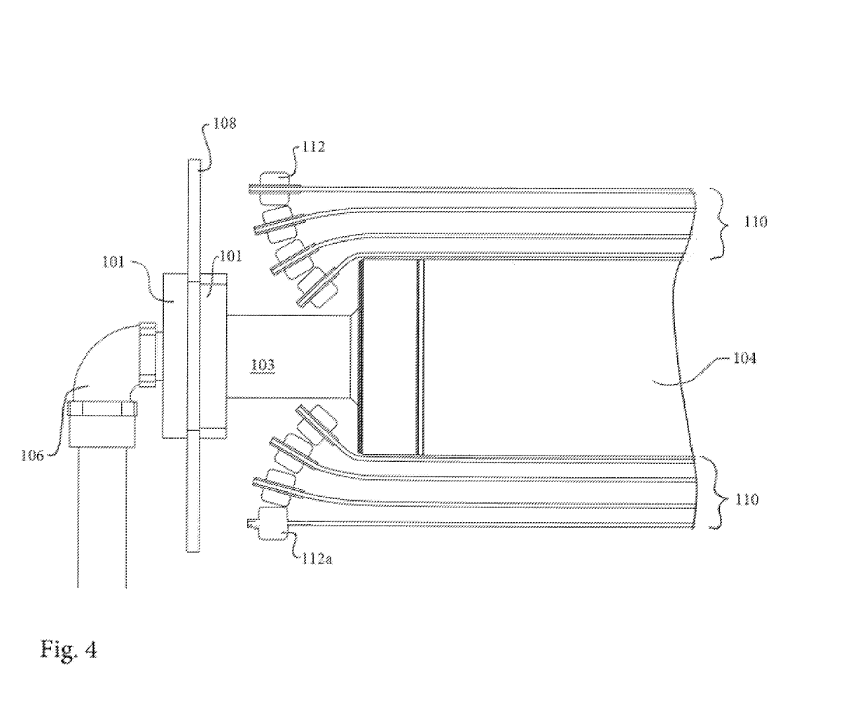

FIG. 4 is a section view showing the left side the curtain 110, with the end poppers 112 wound around the roller barrel assembly 104. In contrast with the situation in FIG. 1, in which the end poppers 112, when the curtain 110 has been wound onto the roller barrel assembly 104, are bunched up to produce a significantly greater diameter in the vicinity of the end poppers 112, in the invention as illustrated in FIG. 4, the presence of the inventive reduced motor drive shaft 103 creates a region of smaller diameter around which the edge portions of the curtain 110 are wound.

As can be seen in FIG. 4, as a result of this reduced diameter region at the reduced motor drive shaft 103, the curtain 110, even at its edge portions when rolled up, has substantially the same diameter throughout. That is, by virtue of the reduced diameter motor drive shaft 103, the diameter of the rolled up curtain 110 at the edge areas with the end poppers 112, is substantially identical with the diameter of the rolled up curtain 110 over the remaining longitudinal extent of the roller barrel assembly 104.

Preferably, the other side (right-hand side) of the curtain 110 would have the end poppers 112 wind up over a similarly smaller diameter shaft, although the shaft on the other (in this case right) side might be a smaller diameter passive shaft, i.e., not a shaft coupled directly to a motor, in the case that the motor drive is only supplied at one side of the curtain assembly. Such a passive shaft would also serve to roll up the right edge portion of the curtain 110 while maintaining an even diameter across the longitudinal extent of the curtain 110. Alternatively, the other side (e.g., the right side in this example) could have its own motor, in which case the mechanism would be a mirror image of the mechanism shown in FIGS. 2-4.

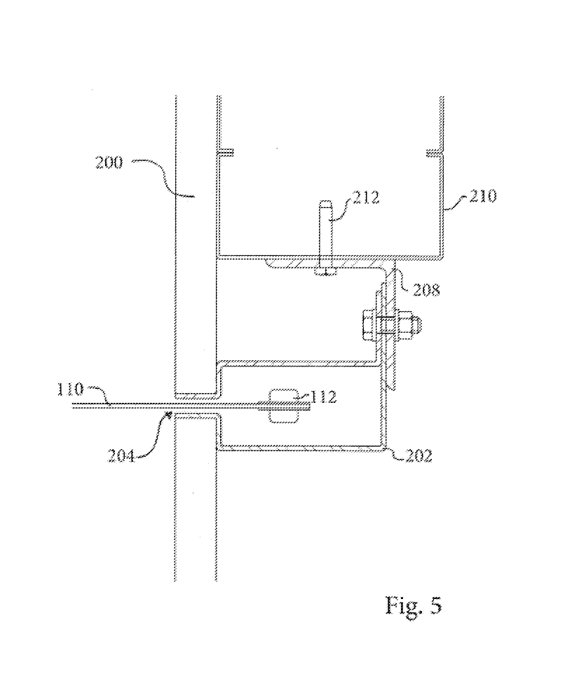

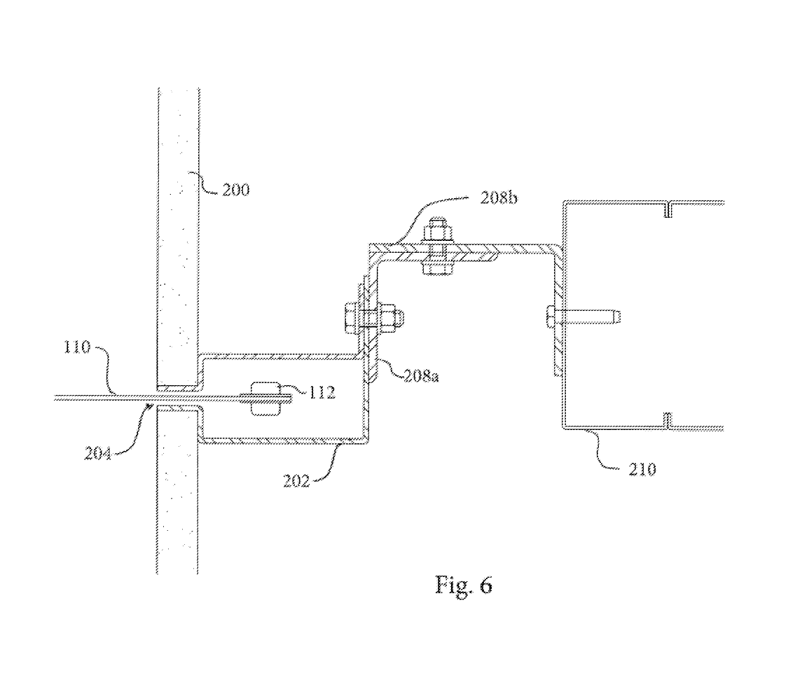

FIGS. 5 and 6 show different assembly options for attaching the assembly to a fire rated wall 200, having a guide 202 within which the edge of the curtain 110 and the end poppers 112 ride during take up and deployment of the curtain 110. Both figures are sectional views.

In the embodiment of FIG. 5, the guide 202 has a narrower portion 204 that allows the curtain 110 to pass through but which prevents the edge of the curtain 110 having the end poppers 112 from disengaging from the curtain 110 assembly. Thus, when the curtain 110 is deployed in an assembly, the end poppers 112 are positioned in the guides 202 (one provided on each side of the area to be traversed by the curtain 110) and the narrower portion 204 prevents the edges of the curtain 110 from disengaging from the guides 202 in the event of a pressure differential from one side of the curtain 110 to the other—such as in a fire or wind condition. The guide 202 is preferably produced from 14 gauge steel, although any suitable material can be used.

FIG. 5 in particular shows a guide 202 assembly for a face mounted drywall application. In this embodiment, the narrower portion 204 protrudes through a gap in the fire rated wall 200, while the other end of the guide 202 is affixed, for example by a nut and bolt assembly, to a mounting angle 208. The mounting angle 208 permits the guide 202 to be affixed, via a screw 212, to a support 210.

FIG. 6 shows a guide 202 assembly for a jamb mounted drywall application. In such a configuration, the narrower portion 204 of the guide 202 protrudes through a gap in the fire rated wall 200, while the other end of the guide 202 is affixed, for example by a nut and bolt assembly, to a first mounting angle 208a. The first mounting angle 208a is affixed, via a second nut and bolt assembly, to a second mounting angle 208b, which permits the guide 202 to be ultimately coupled to a support 210, via a screw 212.

The separation of the poppers along each curtain edge is a matter of design choice which may depend on a particular standard or fire rating, or the overall requirements of the assembly. This the poppers may be sparsely separated or closely separated.

Although the preferred embodiment has been described above in connection with a vertical fire curtain wherein the locking members are positioned along right-side and left-side edges of a curtain deployable between up and down positions, the invention is also for use in other fire curtain assemblies, such as a side-coiling assembly where the curtain is deployed from side-to side across an opening having guides at a top and bottom. Likewise, the assembly can be used in a horizontal curtain assembly such as the type used to secure a stairwell in the case of a fire or smoke condition by deploying the fire curtain in a horizontal or curved configuration.

While the invention has been shown, for purposes of illustration, with respect to disclosed exemplary embodiments, the invention is not limited to the disclosed exemplary embodiments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A curtain assembly, comprising:
a curtain moveable about an opening in a structure, wherein the opening is defined by sides;
a pair of supports brackets;
a curtain deployable about the opening in a direction of travel, said curtain having lateral side edges;
a locking member arranged at each lateral side edge of the curtain transverse to the direction of travel;
a respective guide at each side of the opening for receiving a corresponding side edge of the curtain, each respective guide having a narrower portion that allows the curtain to pass therethrough but restricts the lateral side edge portions of the curtain from disengaging from the guides;
a roller barrel assembly positioned between the support brackets, said roller barrel assembly having a first diameter and configured as a take up roller that stores the curtain in an un-deployed or partially deployed condition, said roller barrel assembly having regions of a second diameter, less than the first diameter, in alignment with the locking members to provide a volume of space for the lateral side edge portions of the curtain having the locking member when the curtain is in the un-deployed or partially deployed condition.

2. The curtain assembly of claim 1, further comprising at least one tubular motor drive unit arranged at a first lateral end of the roller barrel assembly.

3. The curtain assembly of claim 1, wherein each locking member is configured as a plurality of locking members arranged at opposite lateral edge portions of the curtain and spaced from one another along an extent of the curtain in the direction of travel.

4. The curtain assembly of claim 1, wherein each locking member is configured as a thickening at each lateral edge portion of the curtain along an extent of the curtain in the direction of travel.

5. The curtain assembly of claim 2, further comprising motor drive support and locking blocks arranged at at least one of the support brackets.

6. The curtain assembly of claim 2, wherein the regions of a second diameter comprise a reduced motor drive shaft of the at least one tubular motor drive unit.

7. The curtain assembly of claim 2, further comprising a second tubular motor drive unit arranged at a second lateral end of the roller barrel assembly opposite the first lateral end of the roller barrel assembly.

8. The curtain assembly of claim 7, wherein the second tubular motor drive unit has regions of a second diameter less than the first diameter, in alignment with the locking members at the second lateral end of the roller barrel assembly.

9. The curtain assembly of claim 8, wherein each second diameter shaft is arranged between a respective tubular motor drive unit and a respective support bracket.

11. The curtain assembly of claim 2, wherein one or more electrical connections for the at least one tubular motor drive unit pass through a respective reduced diameter shaft.

12. The curtain assembly of claim 1, wherein each guide is affixed indirectly to a respective side wall by one or more support elements.
